(19) United States
(12) Patent Application Publication
(10) Pub. No.: US 2012/0035792 A1
(43) Pub. Date: Feb. 9, 2012

(54) Hybrid Motor Vehicle Device

(75) Inventors: Alexander DOLPP, Ann Arbor, MI (US); Siegfried SAENGER ZETINA, Sindelfingen (DE); Volker SANCHEN, Stuttgart (DE)

(73) Assignee: Daimler AG, Stuttgart (DE)

(21) Appl. No.: 12/849,913

(22) Filed: Aug. 4, 2010

(51) Int. Cl. B60W 10/06; B60W 20/00

(52) U.S. Cl. 701/22; 903/930

(57) ABSTRACT

A hybrid motor vehicle device with a data input unit, which has at least one operating element for a user input of at least one drive distance parameter, and with a calculating unit, which is provided to adapt a hybrid operating strategy to the at least one drive distance parameter. The calculating unit in at least one hybrid operating mode is provided to assign the at least one operating element to a destination-independent input function of the at least one drive distance parameter characterizing a predicted drive distance.

### BACKGROUND AND SUMMARY OF THE INVENTION

Exemplary embodiments of the invention relate to a hybrid motor vehicle device with an internal combustion engine, a battery device, an electric motor, which is used as the sole drive source, and a data input unit, which has at least one operating element for a user input of at least one drive distance parameter, and with a calculating unit, which is provided to adapt a hybrid operating strategy, by means of which an operation of the internal combustion engine can be activated to the at least one drive distance parameter.

U.S. Pat. No. 5,892,346 discloses a hybrid motor vehicle device with a data input unit which provides a user input for at least one drive distance parameter, and with a calculating unit, which adapts a hybrid operating strategy to the at least one drive distance parameter.

Exemplary embodiments of the present invention provide a constructively simple hybrid motor vehicle device. In particular, exemplary embodiments of the present invention are based on a hybrid motor vehicle device with an internal combustion engine, a battery device and an electric motor, which can be used as the sole drive source. The hybrid motor vehicle device also has a data input unit, which has at least one operating element for a user input of at least one drive distance parameter. The vehicle also includes a calculating unit, which is provided to adapt a hybrid operating strategy to the at least one drive distance parameter. Activation of the internal combustion engine is determined by the hybrid operating strategy.

The calculating unit in at least one operating mode is provided to assign to the at least one operating element a destination-independent input function for the at least one drive distance parameter predicting a drive distance. A constructively particularly simple hybrid motor vehicle device can be provided thereby, which can in particular operate independently of a navigation device.

As used herein, “calculating unit” is a unit with at least one control device. A “control device” is a unit with a processor unit and with a storage unit and with an operating program stored in the storage unit. The calculating unit can basically have several control devices connected amongst one another, which are preferably provided to communicate with each other via a bus system, as in particular a CAN bus system. “Provided” means to be especially programmed, equipped and/or designed. “To assign an input function to the operating element” means that the calculating unit evaluates a signal triggered by actuating the operating element as an input of the drive distance parameter, wherein the calculating unit preferably uses the drive distance parameter input by actuating the operating element directly for adapting the hybrid operating strategy.

“Destination-independent” means the input function can be assigned independently of an input of a definite destination, i.e., the destination-independent input drive distance parameter can basically be assigned to several destinations. The input function can be independent of a navigation unit, i.e., a direct input of the destination can be omitted. “Destination-independent” means an input of the drive distance parameter which is independent of navigation based on a map. The input function is provided at least indirectly for inputting a drive distance, wherein an “indirect input of the drive distance” is an input of the drive distance independent of a definite distance input, for example in kilometers or miles, to which the calculating unit can adapt the hybrid operating strategy. “At least one drive distance parameter” means that the data input unit provides at least one, preferably several different drive distance parameters.

The hybrid motor vehicle device can, for example, be designed as a so-called hybrid in series or in parallel. With a hybrid in series, the drive takes place using an electric motor. The energy necessary for this is supplied either by the battery device or it is generated by a generator, which is driven by the internal combustion engine. It can furthermore also be possible to couple the internal combustion engine directly to an output of the hybrid motor vehicle device. With a parallel hybrid, the electric motor and/or the internal combustion engine can be used for the drive. The electric motor can also be used as a generator in this case, by means of which the battery device can be charged.

The data input unit can be provided to transmit a predicted drive distance as the drive distance parameter to the calculating unit. A hybrid strategy can thereby advantageously be adjusted to a drive distance predicted by the operator, whereby operating costs can especially be reduced. A “predicted drive distance” means a drive distance assumed by an operator, preferably up to a next charging possibility for the battery device. A “charging possibility” means an external current supply, to which the hybrid motor vehicle device can be connected to charge the battery device. An “external current supply” can be, for example, a national grid. An external battery device or an external generator can basically also be the external energy source.

The calculating unit can have at least a first and a second hybrid operating mode and the data input unit is provided for selecting the hybrid operating modes. A hybrid operating mode can thereby be selected in a simple manner. A “hybrid operating mode” means a mode of the calculating unit in which an operating program stored on the calculating unit is carried out for the hybrid drive device.

The first hybrid operating mode is a long distance hybrid operating mode, in which the calculating unit is provided to give the drive distance parameter depending on a charging state. A drive distance parameter can thereby be advantageously adjusted to the charging state of the battery device. A “charging state” means to be a charging state or an SOC of a battery device. A low charging state value thereby shows a low charging state and a high charging state value a high charging state of the battery device. “Give” is thereby meant as the calculating unit calculating the long distance parameter and this is then taken up directly or can optionally also be changed manually by the operator.

The calculating unit can be provided to calculate a maximum purely electrical drive distance in the long distance hybrid operating mode and to give a multiple of the purely electrical drive distance as drive distance parameter. The calculating unit for drive distances larger than the purely electrical drive distance can thereby provide a hybrid strategy optimized to the charging state of the battery device in a particularly simple manner. A “purely electrical drive distance” means a drive distance which can be covered in a purely electrical drive mode, wherein the energy is solely provided by the battery device.

In a further arrangement the calculating unit is provided to assign a selecting function to the operating element for the direct selection of the first hybrid operating mode. A first hybrid operating mode can thereby be activated by an operator in a particularly simple manner.

The hybrid drive device can have a key button which forms the at least one operating element. The operating element can thereby be realized constructively in a particular simple and cost-efficient manner. A “key button” means a mechanical component which transmits an electrical or electronic pulse to the calculating unity when actuated.

The calculating unit can be provided to assign an input function to the at least one operating element for a drive distance desired by an operator. An operator can thereby enter a definite drive distance in a particularly simple manner, whereby in particular the drive distance parameter can be adjusted exactly to the drive distance predicted by an operator.

The data input unit can be provided to transmit an allowance for a purely electrical drive distance to the calculating unit as a further drive distance parameter. The calculating unit then adjusts the charging state of the battery device in such a manner that a drive distance entered as an allowance can still be securely driven in a purely electric manner. If the driver only carries out the input of the allowance if the actual charging state for the required allowance is no longer sufficient, the calculating unit increases the charging state to the necessary measure. The driver himself can request the start of the purely electrical driving using an operating element. It is, however, also possible that the purely electrical driving is started automatically if the allowance corresponds to the remaining predicted drive distance. This is especially advantageous if the destination is in a region in which is to be driven in a purely electrical manner. This is, for example, the case if the destination is in an inner city or a residential area.

The data input unit can be provided to transmit a drive distance profile to the calculating unit as a further drive distance parameter. A hybrid strategy can thereby be optimized particularly well. A “drive distance profile” means a division of the predicted drive distance into drive distance speed profiles. “Drive distance speed profiles” means average speeds assumed for distances, as especially for within towns, highways, or superhighways. The drive distance profile can be input as a sequence of length indications of the individual drive distance speed profiles. The length indications can be, for example, designated in miles or kilometers.

The calculating unit can be provided to assign a destination-independent input function for the drive distance profile to the at least one operating element. An operator can thereby input the drive distance profile in a particularly simple manner.

The calculating unit can be provided to assign a selecting function for the direct selection of the second hybrid operating mode to the at least one operating element, wherein the calculating unit is provided to hold or increase a charging state. An operator can thereby switch over to the second hybrid operating mode in a particularly simple manner.

In a further arrangement the hybrid drive device has a storage unit which is provided to store at least one drive distance parameter set with at least one destination-independent drive distance parameter. Destinations approached often can thereby be stored in the storage unit in an advantageous and retrievable manner. Only destination-independent drive distance parameters shall thereby be stored in particular. A “drive distance parameter set” means a data set with successive drive distance parameters which can be stored in the storage unit. A drive distance parameter set thereby forms a drive distance profile for a certain distance.

The calculating unit can also be provided to store a driven distance data set in the storage unit. A drive distance parameter and the drive distance profile can thereby be verified and optimized in an advantageous manner for a distance to be driven often. A “driven distance data set” means properties of a driven distance from a staring point to an end point. The starting point and the end point thereby preferably have a charging possibility for the hybrid drive device, where the charging state of the battery device can be brought to a maximum. “Properties of the distance” means at least a drive distance profile, an energy requirement and/or an exact drive distance. Basically, even more properties of the distance can be stored in the storage unit.

It is additionally suggested that the calculating unit is provided to assign a selecting function for the selection of the at least one drive distance parameter stored in the storage unit to the at least one operating element. An operator can thereby retrieve the drive distance parameter set stored in the storage unit in a particularly simple manner.

The calculating unit can be independent of a navigation unit. A particularly simple and cost-efficient hybrid drive device can thereby be provided. “Independent of a navigation unit” means that the calculating unit for determining the drive distance parameter operates in an self-sufficient manner from a map-supported navigation system, as for example a satellite-controlled positioning system, for example GPS.

The calculating unit can have a short distance operating mode, in which it is provided to switch to a purely electrical drive mode. The internal combustion engine can thereby remain switched off in an operating mode, in which the energy of the internal combustion engine is not needed, in order to thus in particular use a cost-efficient energy for the drive.

The hybrid drive device has a charging device for the connection to a charging possibility, which is provided to charge the battery device. A charging state of the battery device can thereby be increased in a particularly cost-efficient manner.

Further advantages result from the following description of the drawings. An embodiment of the invention is shown in the drawing. The drawing, the description and the claims contain numerous characteristics in combination. The skilled artisan will conveniently also view the characteristics individually and combine them to sensible further combinations.

### BRIEF DESCRIPTION OF THE DRAWING FIGURE

FIG. 1 shows a schematized depiction of a hybrid motor vehicle device.

### DETAILED DESCRIPTION OF THE PREFERRED EMBODIMENTS

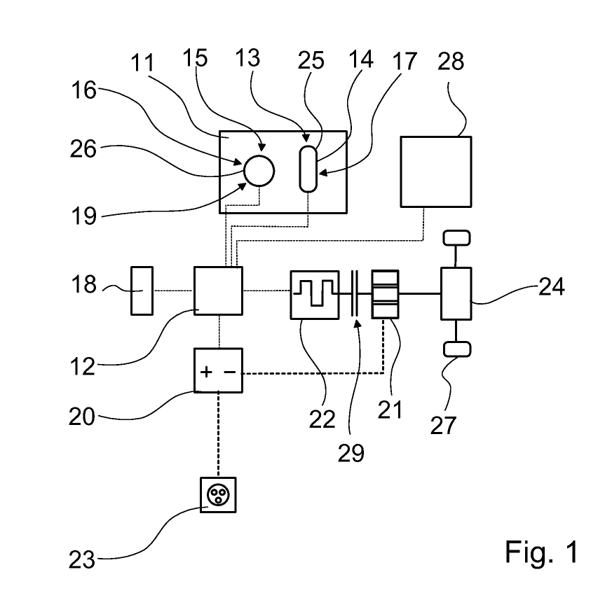

The hybrid motor vehicle device of FIG. 1 has two drive machines which are provided for driving a hybrid motor vehicle, not shown in detail. The hybrid vehicle is driven via at least two drive wheels 27. The hybrid vehicle is a plug-in hybrid vehicle. The first drive machine is an electric motor 21. The second drive machine is an internal combustion engine 22. The hybrid motor vehicle device has a transmission device 24. The electric motor 21 and the internal combustion engine 22 are arranged in series with regard to each other. The electric motor 21 is arranged between the internal combustion engine 22 and the transmission device 24 on an output shaft of the internal combustion engine 22. The drive connection between the internal combustion engine 22 and the electric motor 21 can be separated using a clutch 29, which can be, for example, designed as a multiple disk clutch. A drive for the hybrid vehicle can either take place purely by the electric motor 21, purely by the internal combustion engine 22, or by a combination of electric motor 21 and internal combustion engine 22. The electric motor 21 and also the internal combustion engine 22 can thereby introduce a torque into the output shaft of the internal combustion engine 22.

The hybrid motor vehicle device has a battery device 20. The battery device 20 stores an electrical energy, with which the electric motor 21 can be driven. The electric motor 21 can be operated in a generator operation, in which the electric motor 21 is driven by the internal combustion engine 22 and thus generates a current. The current can be fed into the battery device 20. The battery device 20 can be charged using the electric motor 21 and the internal combustion engine 22. The battery device 20 has a charging state. The charging state of the battery device indicates how much current is present in the battery device 20 and can be used for operating the hybrid drive device. The charging state has a charging state minimum, from which a current supply of the electric motor 21 is insufficient for a drive.

The hybrid motor vehicle device has a charging device 23 for a charging process of the battery device 20 from an external current supply grid. The charging device 23 has at least one electrical plug, which can be connected to an external current supply grid for charging the battery device 20.

The hybrid vehicle device further has a calculating unit 12. The calculating unit 12 is formed independent of a navigation unit. The calculating unit 12 is provided to regulate a hybrid operating strategy of the hybrid motor vehicle and to adapt it to a drive distance parameter. The hybrid motor vehicle device has three drive modes. The calculating unit 12 selects one of the drive modes accounting for the drive distance parameter.

A first drive mode is a purely internal combustion engine drive mode. In the first drive mode, the internal combustion engine 22 is used for driving the hybrid motor vehicle. The internal combustion engine 22 is operated using a fuel which is stored in a tank, not shown in detail. By the combustion of the fuel, the internal combustion engine 22 generates a torque which is introduced into the transmission device 24. In the first drive mode, the electric motor 21 can be used in a generator operation to generate current and to feed it to the battery device 20. A charging state of the battery device 20 can thereby be held or increased in the first drive mode.

A second drive mode is a purely electrical drive mode. In the purely electrical drive mode, only the electric motor 21 is used for driving the hybrid vehicle. The drive connection between the internal combustion engine 22 and the electric motor 21 is thereby separated using the clutch 29. The electric motor 21 is supplied with current from the battery device 20. For driving the hybrid motor vehicle, the electric motor 21 generates a torque which is introduced into the transmission device 24. The battery device 20 is discharged in the second drive mode by the electric motor 21, whereby the charging state of the battery device 20 reduces.

A third drive mode is a hybrid drive mode. In the third drive mode, the electric motor 21 and the internal combustion engine 22 drive the hybrid motor vehicle. The electric motor 21 and the internal combustion engine 22 respectively generate a torque, which are combined and introduced into the transmission device 24. The internal combustion engine 22 is operated in the third drive mode, depending on a required drive torque, if possible in an advantageous operating region. The electric motor 21 applies a torque in the third operating mode which is needed to achieve the drive torque required by a driver. If the required drive torque is smaller than the torque that the internal combustion engine 22 issues in the favorable operating mode, the electric motor 21 switches into the generator operation and thus taps the excessive torque. The battery device 20 is then charged.

The hybrid motor vehicle device has a data input unit for inputting a drive distance parameter. The data input unit 11 is provided to enable the input of a drive distance parameter for the operator. The data input unit 11 has an operating element 13. The calculating unit 12 is provided to assign a destination-independent input function for the drive distance parameter to the operating element 13. The data input unit 11 is provided to transmit the drive distance parameter, which is a predicted drive distance, to the calculating unit 12.

The calculating unit 12 comprises a long distance hybrid operating mode as a first hybrid operating mode and a charge hybrid operating mode for charging the battery device 20 as a second hybrid operating mode. The calculating unit 12 additionally comprises a short distance hybrid operating mode as a further hybrid operating mode. The data input unit 11 is provided for a selection of the hybrid operating modes. The data input unit 11 has an operating element 14, to which the calculating unit 12 assigns a selecting function for the direct selection of the first hybrid operating mode. The operator can select the first hybrid operating mode directly by actuating the operating element. The first operating mode is the long distance hybrid operating mode. The calculating unit 12 gives a drive distance parameter in the long distance hybrid operating mode depending on the charging state of the battery device 20. The calculating unit 12 determines from the charging state a possible pure electrical drive distance and gives a multiple of the possible pure electric drive distance as drive distance parameter. In the first hybrid operating mode, the calculating unit 12 activates the hybrid drive mode of the hybrid drive device.

The data input unit 11 has an operating element 12 for inputting a drive distance desired by an operator. The calculating unit 12 assigns an input function for the drive distance desired by the operator to the operating element 15. The operator can input a value for the desired drive distance in the long distance hybrid operating mode using the operating element 15. The drive distance desired by the operator is transmitted to the calculating unit 12 as predicted drive distance using the data input unit 11. If the desired drive distance input by the operator is smaller than the possible purely electrical drive distance, the calculating unit switches to a short distance hybrid operating mode. The calculating unit 12 activates the purely electrical drive mode in the short distance hybrid operating mode.

The driver can also input an allowance for a purely electrical drive distance via the operating element, which it transmits to the data input unit at the calculating unit 12. The calculating unit then adjusts the charging state of the battery device in such a manner that a drive distance entered as an allowance can still be securely driven in a purely electric manner. The driver can start the purely electrical drive with an operating unit, not shown.

The data input unit 11 is provided to transmit a drive distance profile to the calculating unit 12 as further drive distance parameter. The data input unit 11 has an operating element 16 for inputting the drive distance profile. The calculating unit 12 assigns a destination-independent input function for the drive distance profile to the operating element 16. The operator can input the drive distance profile of the desired drive distance via the operating element. The operator can thereby divide the desired drive distance into different drive distance speed profiles, as for example in town, highway and superhighway. A division of the distance thereby takes place via a distance indication, which is covered in the respective distance speed profile. Basically, only one indication of the predominant path speed profile can be carried out.

The hybrid drive device has a storage unit 18 for storing a destination-independent drive distance parameter. The calculating unit 12 is provided to store a driven distance data set in the storage unit 18. The data input unit 11 has an operating element 19 for selecting a drive distance parameter stored in the storage unit 18.

The second hybrid operating mode is the charge hybrid operating mode. The data input unit 11 has an operating element 17, which the operator can use to select the second hybrid operating mode. The calculating unit 12 allocates a selecting function to the operating element 17 for the direct selection of the second hybrid operating mode. In the second hybrid operating mode, the calculating unit 12 is provided to increase a charging state of the battery device 20. For increasing the charging state of the battery device 20, the electric motor 21 is used as a generator during the second hybrid operating mode. The calculating unit 12 activates the purely internal combustion engine motor drive mode for the second hybrid operating mode. A part of the torque generated by the internal combustion engine 22 is converted to a current by the electric motor 21 operated by a generator and a second part of the torque is used for driving the hybrid motor vehicle via the transmission device 24. A charging state of the battery device 20 can basically also only be held in the second hybrid operating mode.

The hybrid drive device has a key button 25. The key button 25 forms the operating element 13, the operating element 14 and the operating element 17. The key button 25 is a push button that can be reached easily in a driver region of the hybrid motor vehicle. The hybrid drive device has a rotary knob 26 for inputting the drive distance and the drive distance profile desired by the driver. The rotary knob 26 forms the operating element 15, the operating element 16 and the operating element 19. The key button 25 and the rotating button are designed as separate components in this embodiment of the hybrid drive device, but can also be formed integrally, for example using a push-rotary button. All functions of the operating elements 13, 14, 15, 16, 17, 19 can basically also be formed using a touch screen, which is mounted in the driver region, for example a center console.

The hybrid drive device has a display unit 28 for visualizing the operating mode carried out by the calculating unit 12. The display unit 28 is a display which is arranged in the driver region of the hybrid vehicle and which can be viewed easily by the operator. The display unit 28 can also be formed integrally with the touch screen. The display unit 28 displays the operating mode of the hybrid drive device. A symbol is assigned to each operating mode, which displays on the display unit 28, when the corresponding operating mode is active. If the operating mode of the hybrid drive device is changed by actuating the key button 25, the display device 28 shows this by the change of the symbol for the active operating mode. Instead of symbols, characters or other visualizations can also be displayed for the active operating mode of the display device.

If the operator actuates the key button 25 while the hybrid drive device is in a normal operating mode, the calculating unit 12 switches directly to the long distance hybrid operating mode. The calculating unit 12 first calculates the possible purely electrical drive distance from the charging state of the battery device 20 and adjusts the drive distance parameter to twice of the purely electrical drive distance. The operator subsequently has the opportunity to adjust a distinct predicted drive distance via the rotary knob 26. If no drive distance is input by the driver, the calculating unit adopts twice the purely electrical drive distance as drive distance parameter. The calculating unit 12 adapts the hybrid strategy of the hybrid drive device to the drive distance parameter that is taken on. The hybrid strategy is adapted by the calculating unit 12 for an optimal use of the energy available on the battery device. The energy stored in the battery device 20 is divided in such a manner that it can be used for the entire drive distance defined over the drive distance parameter and the internal combustion engine 22 can be operated in a favorable operating point as often as possible. The charging state of the battery device 20 ideally has a charging state minimum after completing a drive which corresponds to a drive distance of the input drive distance parameter.

If the operator actuates the key button 25 while the hybrid drive device is in the long distance hybrid operating mode, the calculating unit switches to the charging operating mode. Using a renewed actuation of the key button 25, while the hybrid drive device is in the charging operating mode, the calculating unit 12 further switches into the normal operating mode of the hybrid drive device. Using a third actuation of the key button 25, the calculating unit again switches to the long distance hybrid operating mode.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A hybrid motor vehicle device, comprising:
an internal combustion engine;
a battery device;
an electric motor, which is used as a sole drive source;
a data input unit, which has at least one operating element for a user input of at least one drive distance parameter; and
a calculating unit, which adapts a hybrid operating strategy, wherein the hybrid operating strategy controls activation of the internal combustion engine according to the at least one drive distance parameter,
wherein the calculating unit, in at least one operating mode, assigns a destination-independent input function as the at least one drive distance parameter characterizing a predicted drive distance.

2. A hybrid drive device according to claim 1, wherein the data input unit transmits a predicted drive distance to the calculating unit as the at least one drive distance parameter.

3. A hybrid drive device according to claim 1, wherein the calculating unit has at least a first and a second hybrid operating mode and the data input unit allows selection of the hybrid operating modes.

4. A hybrid drive device according to claim 3, wherein the first hybrid operating mode is a long distance hybrid operating mode in which the calculating unit provides the drive distance parameter depending on a charging state.

5. A hybrid drive device according to claim 4, wherein the calculating unit calculates a maximum purely electrical drive distance in the long distance hybrid operating mode and provides a multiple of the purely electrical drive distance as drive distance parameter.

6. A hybrid drive device according to claim 3, wherein the calculating unit assigns a selecting function for the direct selection of the first hybrid operating mode to the at least one operating element.

7. A hybrid drive device according to claim 6, wherein the at least one operating element is a key button.

8. A hybrid drive device according to claim 1, wherein the calculating unit assigns an input function for a drive distance desired by an operator to the at least one operating element.

9. A hybrid drive device according to claim 1, wherein the data input unit transmits an allowance for a purely electrical drive distance to the calculating unit as a further drive distance parameter.

10. A hybrid drive device according to claim 1, wherein the data input unit transmits a drive distance profile to the calculating unit as a further drive distance parameter.

11. A hybrid drive device according to claim 10, wherein the calculating unit assigns a destination-independent input function for the drive distance profile to the at least one operating element.

12. A hybrid drive device according to claim 3, wherein the calculating unit assigns a selection function for the direct selection of the second hybrid operating mode to the at least one operating element, wherein the calculating unit holds or increases a charging state.

13. A hybrid drive device according to claim 1, comprising:
a storage unit that stores at least one drive distance parameter set with at least one destination-independent drive distance parameter.

14. A hybrid drive device according to claim 13, wherein the calculating unit saves a driven distance data set in the storage unit.

15. A hybrid drive device according to claim 14, wherein the calculating unit assigns a selection function for the selection of the at least one drive distance parameter stored in the storage unit to the at least one operating element.

16. A hybrid drive device according to claim 1, wherein the calculating unit is independent of a navigation unit.

17. A hybrid drive device according to claim 1, wherein the calculating unit has a short distance operating mode, in which it switches to a purely electrical drive mode.

18. A hybrid drive device according to claim 1, comprising:
a charging device that charges the battery device.

19. A method for a hybrid motor vehicle device that comprises an internal combustion engine, a battery device, an electric motor, which is used as the sole drive source, a data input unit and a calculating unit, the method comprising:
receiving, by at least one operating element of the data input unit, input of at least one drive distance parameter;
adapting, by the calculating unit, a hybrid operating strategy that controls activation of the internal combustion engine according to the at least one drive distance parameter; and
assigning, by the calculating unit in at least one operating mode, a destination-independent input function for the at least one drive distance parameter characterizing a predicted drive distance.
